(19) United States
(12) Patent Application Publication
(10) Pub. No.: US 2026/0236905 A1
(43) Pub. Date: Aug. 13, 2026

(54) Device Evaluation Based on Hybrid Language Models

(71) Applicant: Bank of America Corporation, Charlotte, NC (US)

(72) Inventors: Saurabh Arora, Haryana (IN); Sandeep Kumar Chauhan, Telangana (IN); Nandini Rathaur, Mumbai (IN); Sneha Padiyar, East Mumbai (IN)

(21) Appl. No.: 19/050,448

(22) Filed: Feb. 11, 2025

(51) Int. Cl. G06Q 20/30; G06N 20/00; G06Q 20/40

(52) U.S. Cl. CPC G06Q 20/30; G06N 20/00; G06Q 20/40

(57) ABSTRACT

Arrangements for leveraging hybrid learning models for device evaluation are provided. In some examples, a computing platform may train a large language model to output user specific payment device information. The computing platform may execute the large language model to output user specific payment device information for a particular user and may transmit the user specific payment device information to a user computing device of the user. In some examples, the data may be transmitted via a unified language model feed layer that may format the data for further processing by, for instance, a micro language model executing on the user computing device. The computing platform may receive, from the user computing device, an indication of a recommended payment device and an indication of whether the recommended payment device was accepted or used for the transaction. The computing platform may then update and/or validate the large language model.

### BACKGROUND

Aspects of the disclosure relate to electrical computers, systems, and devices for leveraging hybrid language models to evaluate devices, such as payment devices.

Users often have a plurality of payment devices, such as credit cards, debit cards, and the like, each having different benefits or rewards for a user. In some examples, users might not be aware of particular rewards or benefits associated with a device. This can make it difficult for a user to identify, in real-time, a best payment device for a particular transaction. Accordingly, aspects described herein are directed to using various types of language models to process data, in real-time, and identify a particular payment device that would be beneficial to the user for that particular transaction.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with identifying, in real-time, an optimal payment device for use.

In some examples, a computing platform may train a large language model to output user specific payment device information. In some examples, training the large language model may be based on payment device data associated with a plurality of users, financial institution data associated with each payment device, reward or benefit data associated with each payment device, and the like.

The computing platform may execute the large language model to output user specific payment device information for a particular user and may transmit the user specific payment device information to a user computing device of the user. In some examples, the data may be transmitted via a unified language model feed layer that may format the data for further processing by, for instance, a micro language model executing on the user computing device.

The computing platform may receive, from the user computing device, an indication of a recommended payment device and an indication of whether the recommended payment device was accepted or used for the transaction. The computing platform may then update and/or validate the large language model.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1C depict an illustrative computing environment for leveraging hybrid learning models to perform device evaluation in accordance with one or more aspects described herein;

FIGS. 2A-2E depict an illustrative event sequence for leveraging hybrid learning models to perform device evaluation in accordance with one or more aspects described herein;

FIG. 3 illustrates an illustrative method for leveraging hybrid learning models to perform device evaluation according to one or more aspects described herein;

FIG. 4 illustrates another illustrative method for leveraging hybrid learning models to perform device evaluation in accordance with one or more aspects described herein;

FIGS. 5 and 6 depict illustrative user interfaces that may be generated in accordance with one or more aspects described herein; and

FIG. 7 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, often identifying a particular payment device to provide the greatest benefit to a user in real-time and during a transaction can be difficult or impossible, particularly when a user has multiple payment devices to choose from. While machine learning techniques may provide some improvement, executing large language models and/or processing vast amounts of data in real-time during a transaction is not practical or possible in some cases (e.g., large language models cannot be reasonably executed on a mobile device of a user).

Accordingly, aspects described herein provide for leveraging different types of language models, executing on different devices, to process data and provide a recommendation for an optimal payment device in real-time and during a transaction. For instance, a large language model may be executed by a computing platform or server to process vast amounts of payment device data, financial institution data, and the like. Outputs from that model may be used as inputs to a micro language model executing on a user device, such as a mobile device of a user, along with transaction details of an ongoing transaction, to identify an optimal card or payment device for the user for that particular transaction. The identified, recommended payment device may then be provided to the user via a notification displayed on one or more of a user computing device, a point-of-sale device, or the like, and the user may provide user input accepting or rejecting the recommended payment device.

These and various other arrangements will be discussed more fully below.

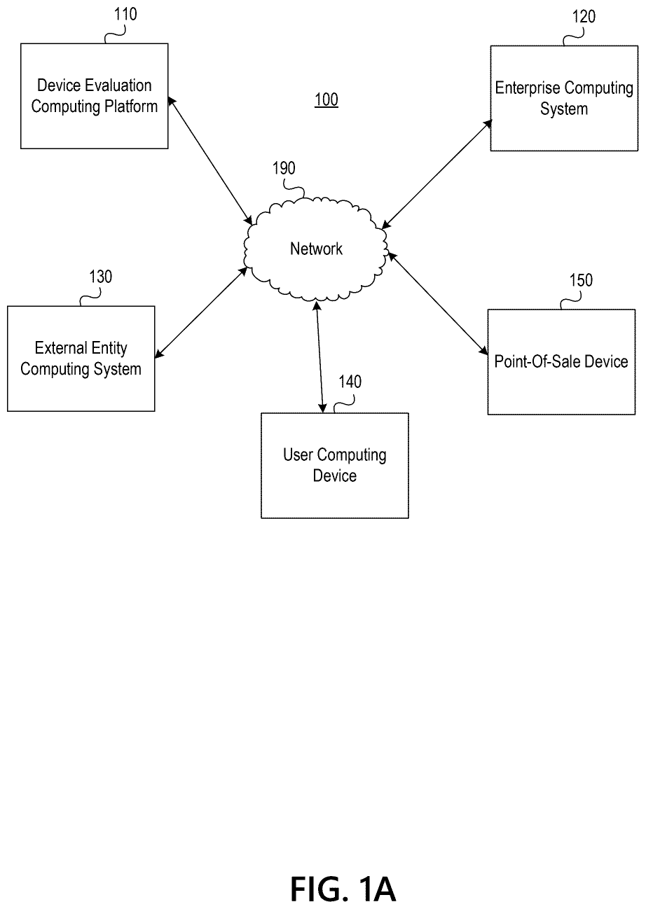

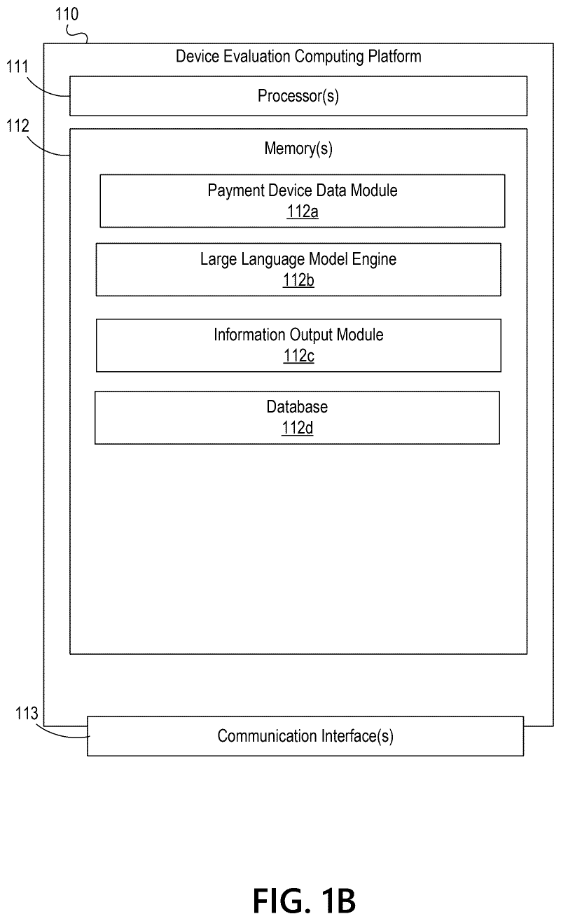

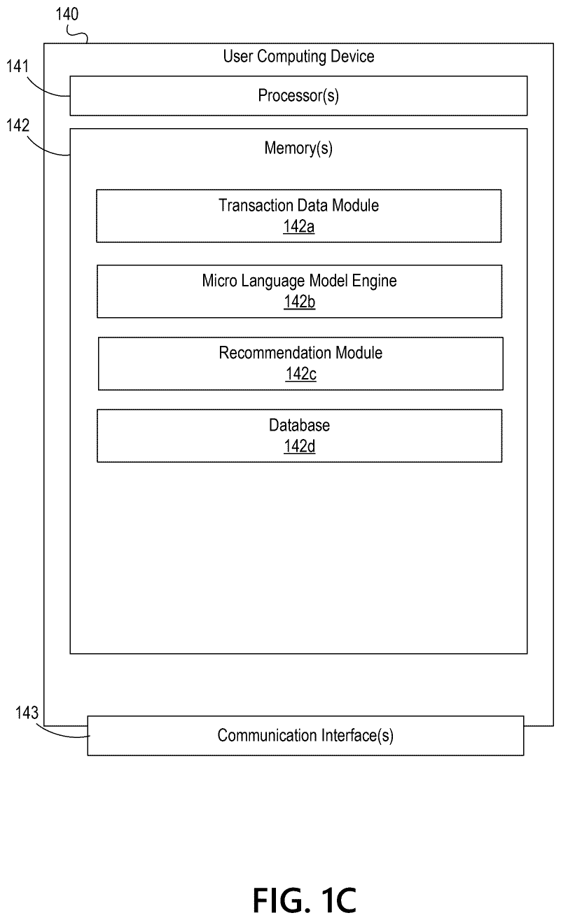

FIGS. 1A-1B depict an illustrative computing environment and devices for leveraging hybrid language models for device evaluation in accordance with one or more aspects described herein. Referring to FIG. 1A, computing environment 100 may include one or more computing devices and/or other computing systems. For example, computing environment 100 may include device evaluation computing platform 110, enterprise computing system 120, external entity computing system 130 and user computing device 140.

Although one enterprise computing system 120, external entity computing system 130 and user computing device 140 are shown, any number of systems or devices may be used without departing from the invention.

Device evaluation computing platform 110 may be or include one or more computer components (e.g., servers, server blade, processor, memory, and the like) and may be configured to perform intelligent, dynamic, real-time evaluation of transactions and user devices, such as payment devices including credit cards, debit cards, and the like, to determine an optimal device for use in a particular transaction. For instance, device evaluation computing platform 110 may receive, from a plurality of users, device information including card numbers, expiration dates, financial institution associated with each device or card, and the like. This data may be used to retrieve, from one or more external entity computing systems 120, information or data related to rewards, benefits, and the like, associated with each device. The device evaluation computing platform 110 may process the data using a large language model to identify, for each user or customer, devices associated with each customer, financial institution associated with each device and rewards or benefits associated with each device. In some examples, historical data including trends (e.g., spending or transaction history or trends, and the like) may be further processed by the large language model to generate or output user or customer device data.

In some examples, a transaction may be initiated via a user computing device, such as user computing device 140, (e.g., as an online purchase or the like), or from a point-of-sale device 150. The user computing device 140 may receive an indication of transaction that may include transaction details (e.g., customer name, payment device being used, amount of transaction, type of purchase, or the like). Based on the indication of transaction, a micro language model executing on user computing device 140 may receive, via a unified language model feed layer, customer or user specific device data from the large language model on the device evaluation computing platform 110. The micro language model may then be executed using the transaction details and customer specific device data as inputs to output a recommended optimal payment device.

In some examples, the recommended payment device may be displayed by a display of the user computing device 140. Additionally or alternatively, the recommended payment device may be transmitted or sent to a point-of-sale device (e.g., at which the transaction was initiated). In some examples, displaying or sending the recommended payment device may include displaying or sending a user interface including the recommended device, as well as additional information related to rewards or benefits that may be associated with using the optimal payment device (e.g., rewards or benefits the user would not receive if proceeding with the initiating payment device). In some arrangements, the user interface may further include a selectable option to request additional information, ask a question, or the like. Selection of that option may initiate an interaction with, for instance, a chat bot, service associate, or the like.

The user may accept or reject the recommended optimal payment device (e.g., via the user interface). This user response data may then be fed back into the system or update and/or validate one or more of the large language model, micro language model, or the like.

In some examples, the device evaluation computing platform 110 may be a separate device, may be part of or include a server executing the large language model and/or may be part of the user computing device 140 executing the micro language model. In some arrangements, the server executing the large language model may be part of the device evaluation computing platform 110 and the user computing device 140 executing the micro language model may be a separate device.

Enterprise computing system 120 may be or include one or more computer components (e.g., servers, server blade, processor, memory, and the like) and may be configured to host or store one or more applications or data including customer data, payment device data, financial institution data, reward or benefit data, and the like. Data from the enterprise computing system 120 may be retrieved and processed by the large language model to train the large language model, generate customer device information, and the like.

External entity computing system 130 may be or include one or more computer components (e.g., servers, server blade, processor, memory, and the like) and may be configured to host or store one or more applications or data including customer and/or payment device data from one or more other financial institutions (e.g., a financial institution different from the enterprise organization executing the device evaluation computing platform 110). For instance, customer or user data, payment device data associated with one or more users or customers, reward or benefit data associated with each payment device, and the like, may be retrieved from external entity computing system 130 and used to train the large language model, generate customer device information, and the like. Although one external entity computing system 130 is shown, data may be received from more than one external entity computing system 130 and/or more than one external entity without departing from the invention.

Uuser computing device 140 may be or include one or more computing devices (e.g., laptop computers, desktop computers, mobile devices, tablet devices, or the like) that may be used by a user or customer to initiate a transaction, receive customer device information, train, execute and update a micro language model, display user interfaces and notifications, and the like. In some examples, user computing device 140 may be used to initiate an interactive conversation with a chat bot, service associate, or the like, to obtain additional information related to one or more recommended optimal payment devices.

Point-of-sale device 150 may be or include one or more computers or computer components (e.g., processor, memory, and the like) and may be arranged at a merchant or retail location to process transactions at the merchant or retail location. The point-of-sale device 150 may be in communication with one or more of device evaluation computing platform 110, user computing device 140, and the like, to display recommended optimal payment device recommendations, receive user input accepting or rejecting the recommended optimal payment device recommendation, and the like.

As mentioned above, computing environment 100 also may include one or more networks, which may interconnect one or more of device evaluation computing platform 110, enterprise computing system 120, external entity computing system 130, user computing device 140 and/or point-of-sale device 150. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, device evaluation computing platform 110, enterprise computing system 120, external entity computing system 130, user computing device 140 and/or point-of-sale device 150 may be connected via network 190.

Referring to FIG. 1B, device evaluation computing platform 110 may include one or more processors 111, memory 112, and communication interface 113. A data bus may interconnect processor(s) 111, memory 112, and communication interface 113. Communication interface 113 may be a network interface configured to support communication between device evaluation computing platform 110 and one or more networks (e.g., network 190, or the like). Memory 112 may include one or more program modules having instructions that when executed by processor(s) 111 cause device evaluation computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of device evaluation computing platform 110 and/or by different computing devices that may form and/or otherwise make up device evaluation computing platform 110.

For example, memory 112 may have, store and/or include payment device data module 112a. Payment device data module 112a may store instructions and/or data that may cause or enable the device evaluation computing platform 110 to receive, from one or more financial institutions and one or more users, payment device information associated with a plurality of users. In some examples, data may be received from a financial institution executing the device evaluation computing platform 110 (e.g., enterprise computing system 120) for payment devices issued by the enterprise organization. Additionally or alternatively, data may be received from one or more external financial institutions (e.g., external entity computing system 130 or the like) for payment devices issued by other financial institutions. The data received may include a type of payment device, an account of each payment device, a financial institution associated with each payment device, current rewards or benefits associated with each payment device, and the like. In some examples, because rewards and/or benefits may change for a particular device, data may be retrieved for payment devices associated with the plurality of users on a periodic or aperiodic basis, to ensure the more current reward information is available for processing.

Device evaluation computing platform 110 may further have, store and/or include large language model engine 112b. Large language model engine 112b may store instructions and/or data that may cause or enable the device evaluation computing platform 110 to train, execute, update and/or validate one or more large language models configured to receive payment device data and output payment device data for a particular user. In some examples, historical payment device data, enterprise organization data, and the like may be used to train the large language model to identify correlations, patterns or sequences in data in order to output payment device data for a particular customer (e.g., customer specific information related to payment devices of a user).

Device evaluation computing platform 110 may further have, store and/or include information output module 112c. Information output module 112c may store instructions and/or data that may cause or enable device evaluation computing platform 110 to transmit or send customer specific information (e.g., as output by the large language model) related to one or more payment devices of a customer to a user computing device (e.g., user computing device 140). In some examples, information output module 112c may include a unified language model feed that may format the data output by the large language model for use or further processing by a micro language model executing on user computing device 140.

Device evaluation computing platform 110 may further have, store and/or include database 112d. Database 112d may store data related to customers or users, payment devices of each customer or user, rewards or benefits associated with each customer, output customer specific information, and/or any other data to perform the functions of device evaluation computing platform 110.

Referring to FIG. 1C, user computing device 140 may include one or more processors 141, memory 142, and communication interface 143. A data bus may interconnect processor(s) 141, memory 142, and communication interface 143. Communication interface 143 may be a network interface configured to support communication between user computing device 140 and one or more networks (e.g., network 190, or the like). Memory 142 may include one or more program modules having instructions that when executed by processor(s) 141 cause user computing device 140 to perform one or more functions described herein and/or one or more databases that may store and/or otherwise maintain information which may be used by such program modules and/or processor(s) 141. In some instances, the one or more program modules and/or databases may be stored by and/or maintained in different memory units of user computing device 140 and/or by different computing devices that may form and/or otherwise make up user computing device 140.

For example, memory 142 may have, store and/or include transaction data module 142a. Transaction data module 142a may store instructions and/or data that may cause or enable the user computing device 140 to receive, from one or more retailers, merchant locations, online merchants, or the like, transaction data associated with an initiated or ongoing transaction (e.g., in real-time). The transaction data may include parties to the transaction (e.g., seller or merchant and purchaser or user), amount of the transaction, type of transaction, type of goods or services being purchased, type of retailer or merchant, or the like.

User computing device 140 may further have, store and/or include micro language model engine 142b. Micro language model engine may store instructions and/or data that may cause or enable the user computing device to train, execute, update and/or validate a micro language model for evaluating transaction data, as well as customer specific payment device data received from, for instance, device evaluation computing platform 110, to identify a recommended optimal payment device for the initiated, ongoing transaction. In some examples, historical transaction data may be used to train the micro language model. For instance, recent transactions of the user associated with the user computing device 140, and/or other users, as well as average amounts spent, favored merchants, transaction patterns captured by the user computing device 140, and the like, may be used to train the micro language model to identify correlations, patterns, or sequences in data in order to generate a recommended optimal payment device. In some examples, the micro language model may be executed in real-time, during an ongoing transaction, using, as inputs, the transaction details of the ongoing transaction, as well as customer specific payment device data received, via the unified language model feed, from the device evaluation computing platform 110 to output the recommended optimal payment device.

User computing device 140 may further have, store and/or include recommendation module 142c. Recommendation module 142c may store instructions and/or data that may cause or enable the user computing device to receive, from the micro language model and in real-time, during a transaction, a recommended optimal payment device. In response, recommendation module 142c may generate a notification (e.g., a user interface) including the recommended optimal payment device and may cause the notification to be displayed by a display of the user computing device 140. Additionally or alternatively, the notification may be transmitted or sent to a point-of-sale device at which the user is conducting the transaction. Transmitting the notification to the point-of-sale device 150 may cause the notification to be displayed by a display of the point-of-sale device 150.

In some examples, the notification may include a selectable option to obtain additional information (e.g., further details about a reward or benefit associated with the recommended optimal payment device, a different in reward or benefit to be received, or the like). The selectable option may be display on the user computing device 140 and, if selected by the user, may prompt display of additional user interfaces including additional information, may connect the user with a chat bot to engage in a virtual communication session, or the like.

User computing device 140 may further have, store and/or include database 142d. Database 142d may store information or data related to user transaction patterns or historical transaction data, frequently visited merchants, recommendations made, and/or any other data to perform the functions of user computing device 140.

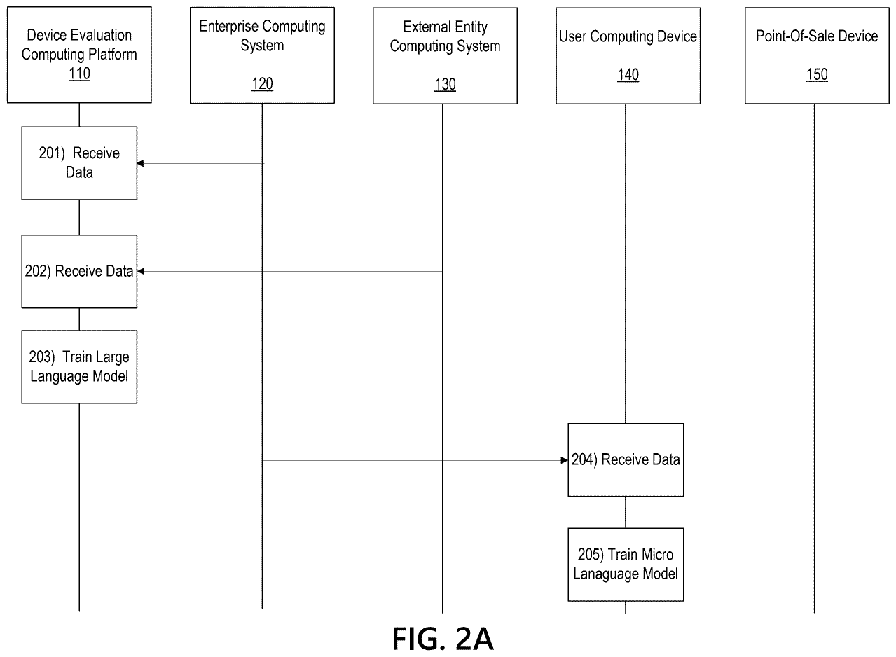

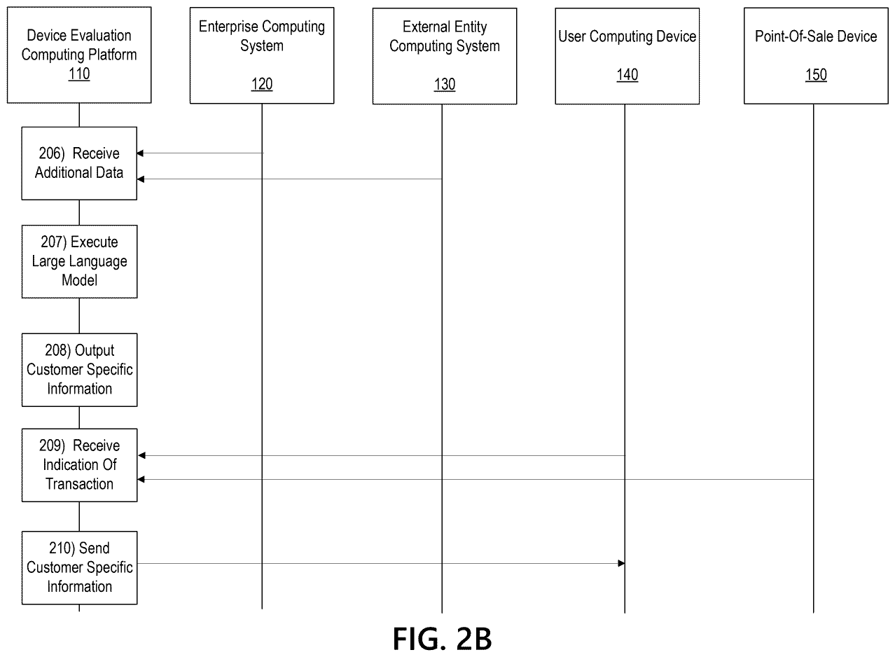

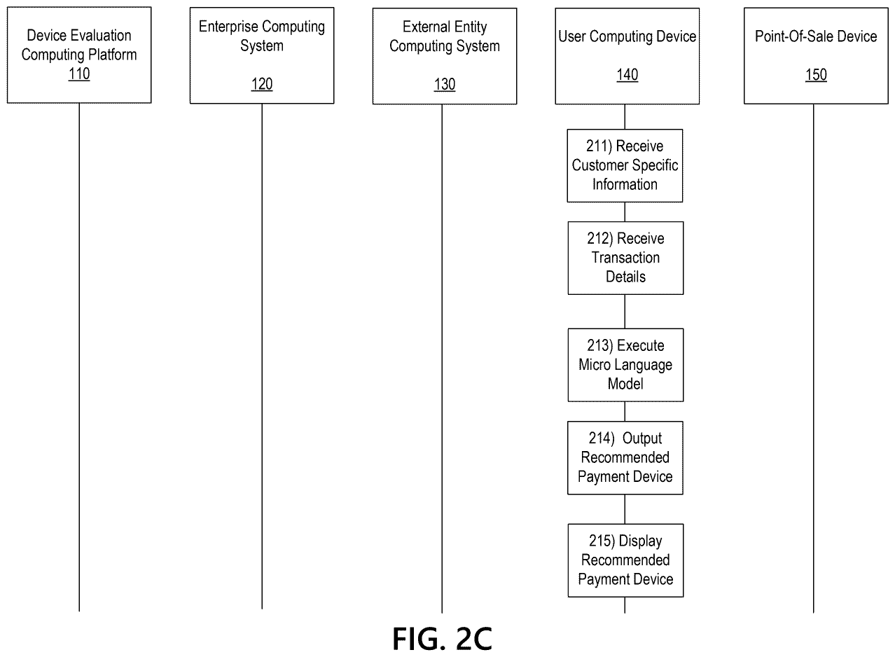

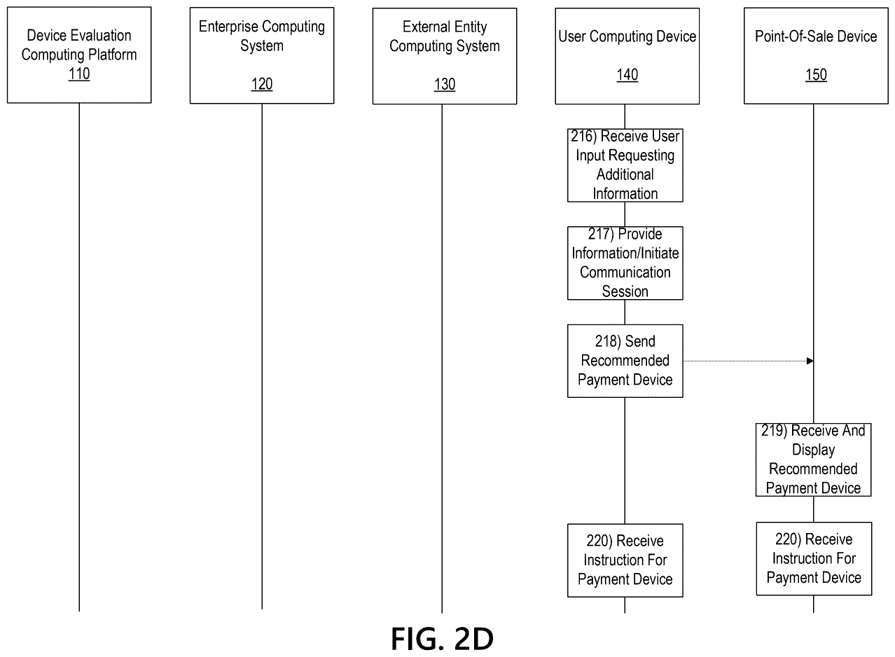

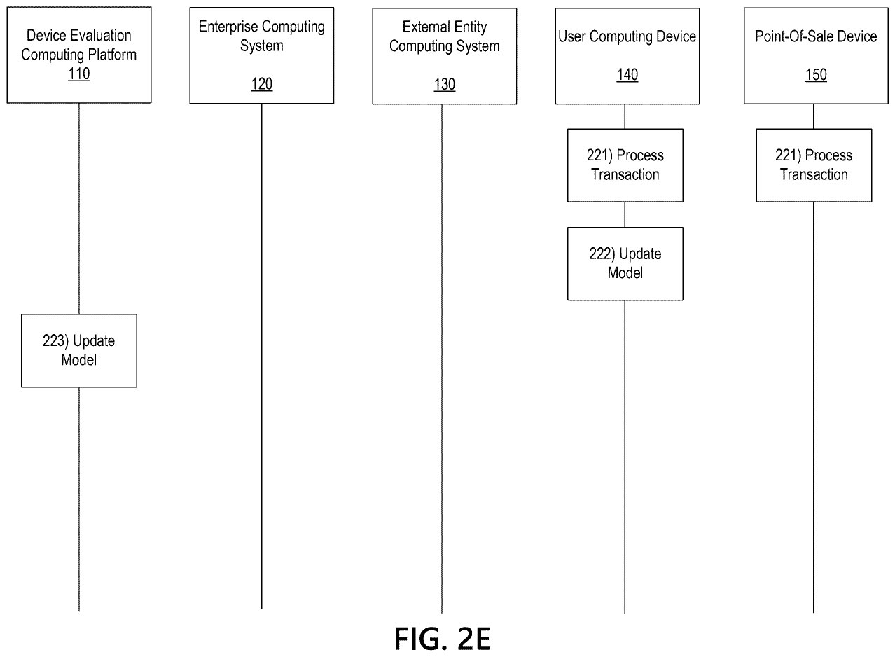

FIGS. 2A-2E depict one example illustrative event sequence for leveraging hybrid data models for device evaluation in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, device evaluation computing platform 110 may receive data from, for instance, enterprise computing system 120. In some examples, device evaluation computing platform 110 may receive data related to one or more users or customers associated with the enterprise organization, historical spending data, payment device information, account information, rewards or benefits associated with one or more payment devices, and the like from the enterprise computing system 120.

At step 202, device evaluation computing platform 110 may receive data from one or more external systems, such as external entity computing system 130. For instance, device evaluation computing platform 110 may receive data related to one or more financial institutions different from the enterprise organization, one or more merchant offers, payment device data associated with payment devices issued by financial institutions other than the enterprise organization, rewards or benefits associated with one or more payment devices, historical transaction data, from, for instance, external entity computing system 130. Although data is shown as being received from one external entity computing system 130, data may be received from a plurality of external entities or external entity computing systems without departing from the invention.

At step 203, device evaluation computing platform 110 may train a large language model. For instance, device evaluation computing platform may feed the data received at steps 201 and 202 into the model to train the large language model to identify correlations, sequences or patterns in data in order to generate or output customer specific payment device data (e.g., payment devices associated with a user, financial institution data associated with the payment devices, rewards or benefits associated with the payment devices, or the like) based on, for instance, a model input (e.g., a request for payment device data associated with a particular user).

In some examples, training the large language model may include using one or more supervised learning techniques (e.g., decision trees, bagging, boosting, random forest, k-NN, linear regression, artificial neural networks, support vector machines, and/or other supervised learning techniques), self-supervised learning techniques (e.g., autoassociative self-supervised learning, contrastive self-supervised learning, non-contrastive self-supervised learning, or the like), unsupervised learning techniques (e.g., classification, regression, clustering, anomaly detection, artificial neutral networks, and/or other unsupervised models/techniques), and/or other techniques.

At step 204, user computing device 140 may receive data from, for instance, enterprise computing system 120. For instance, data related to a user of the user computing device 140, spending history or transaction history for the user, account information and/or payment device information, favored or frequently visited merchants or retailers, or the like, may be received by the user computing device.

At step 205, user computing device 140 may train a micro language model. For instance, user computing device 140 may train a specialized language model (e.g., the micro language model) that is fine tuned to perform narrowly defined tasks focusing on a curated dataset to provide improved accuracy in output. In some examples, user computing device 140 may feed the data received at step 204 (and/or other data stored by the user computing device such as transaction history data, and the like) into the micro language model to train the micro language model to identify stored correlations, sequences or patterns in real-time data related to a particular transaction in order to output a recommended optimal payment device for the transaction.

In some examples, techniques such as model compression, knowledge distillation, and transfer learning may be used to optimize the micro language model. In some arrangements, training the micro language model may include using one or more supervised learning techniques (e.g., decision trees, bagging, boosting, random forest, k-NN, linear regression, artificial neural networks, support vector machines, and/or other supervised learning techniques), self-supervised learning techniques (e.g., autoassociative self-supervised learning, contrastive self-supervised learning, non-contrastive self-supervised learning, or the like), unsupervised learning techniques (e.g., classification, regression, clustering, anomaly detection, artificial neutral networks, and/or other unsupervised models/techniques), and/or other techniques.

With reference to FIG. 2B, at step 206, device evaluation computing platform 110 may receive additional or subsequent data from one or more of enterprise computing system 120, external entity computing system 130, and the like. For instance, subsequent data related to one or more users or customers, payment devices, financial institutions associated with the payment devices, rewards or benefits associated with payment devices, and the like may be received.

At step 207, device evaluation computing platform 110 may execute the large language model. For instance, a customer name or identifier may be input to the large language model, as well as the subsequent data received at step 206, to output, as step 208, customer specific payment device information, such as payment devices associated with the identified customer or user, financial institutions associated with each payment device, current rewards or benefits associated with each payment device, and the like. In some example, the large language model may be executed on a periodic or aperiodic basis to generate and send updated customer specific payment device information to one or more user computing devices 140. In some arrangements, the large language model may output a customized subset of payment devices associated with a particular user. In some examples, the subset may be customized based on historical transaction data of a user, or the like.

Additionally or alternatively, the large language model may be executed upon receiving an indication of initiation of a transaction by a particular user. For instance, at step 209, device evaluation computing platform 110 may receive an indication of initiation of a transaction. In some examples, the indication may be received from the user computing device 140. Additionally or alternatively, the indication may be received from a point-of-sale device 150 at a merchant or retailer. The indication may include identification of the user or customer associated with the transaction, as well as one or more transaction details that may further be used to generate the customized subset of payment devices for the user.

At step 210, device evaluation computing platform 110 may transmit or send the output customer specific payment device information to user computing device 140. In some examples, in transmitting or sending the customer specific payment device information, the device evaluation computing platform may send the customer specific payment device information via a unified language model feed layer that may format or otherwise process the output from the large language model to ensure seamless further input or processing by the micro language model.

With reference to FIG. 2C, at step 211, user computing device 140 may receive the customer specific payment device information.

At step 212, user computing device 140 may receive transaction details of the transaction initiated at step 209 and that may be ongoing. The transaction details may be received in real-time, during the transaction, and may be captured by the user computing device 140 (e.g., if the transaction is being processed via a payment device on the user computing device 140) and/or from the point-of-sale device 150 if the transaction is occurring at the point-of-sale device 150 at the merchant. The transaction details may include parties to the transaction (e.g., customer or purchased, merchant or seller), amount of the transaction, type of transaction, payment device being used for the transaction, and the like.

At step 213, the user computing device 140 may execute the micro language model. For instance, the transaction details and customer specific payment device information received form the device evaluation computing platform 110 may be input to the micro language model and the model may be executed to output, at step 214, a recommended payment device. In some examples, the recommended payment device may be identified based on rewards or benefits that may be available to the user if the user processes the ongoing transaction with the recommended payment device instead of a current payment device being used. Accordingly, in some examples, if the current payment device being used is the recommended payment device, the transaction may continue to be processed without interruption. Alternatively, if a different payment device than the current payment device is the recommended payment device, the ongoing transaction may be paused while the user determines which payment device to use to the process the transaction.

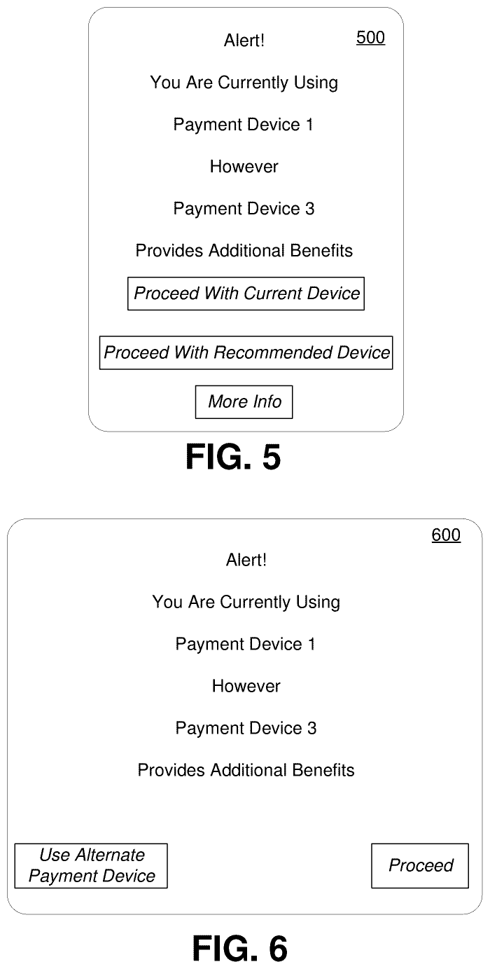

At step 215, the user computing device 140 may display the recommended payment device on a display of the user computing device 140. For instance, a notification or user interface, such as interface 500 in FIG. 5, may be generated and displayed by the user computing device 140. As shown in FIG. 5, the interface may include identification of the recommended payment device, as well as the current payment device being used. In some examples, information related to an additional benefit to be received if the user proceeds with the recommended payment device may be provided.

In some arrangements, the interface 500 may include one or more selectable options. For instance, interface 500 may include an option to proceed with the payment device currently being used, proceed with the recommended payment device identified, or request additional information. If the user selects to proceed with the current payment device, the transaction may proceed as planned. If the user selects the option to use the recommended card, the transaction may be paused or cancelled until the user provides the recommended payment device (e.g., via swipe, contactless payment, chip payment or the like). If the user selects more information, one or more additional interfaces may be provided to the user that may include additional information, may enable a user to ask questions (e.g., to a chat bot or customer service associate), or the like.

In some examples, displaying the recommended payment device may cause the ongoing transaction to be paused while the user considers the options for payment devices. For instance, in some examples, in which the recommended payment device is the current device being used, it is possible that the recommendation may indicate that the user is currently using the best possible payment device and the transaction may continue without pause. If the recommended device is a different payment device than the current device in use, the ongoing transaction may be paused while the user considers the options provided. The transaction may then resume when a selection is made, as shown in FIGS. 2D and 2E.

With reference to FIG. 2D, at step 216, the user computing device 140 may receive user input requesting additional information (e.g., via the selectable option provided with the recommended payment device).

At step 217, user computing device 140 may initiate a communication session with, for instance, a chat bot, customer service associate, or the like, to enable additional information to be provided to the user. In some examples, a user interface including a prompt to ask for additional information may be displayed to the user on the user computing device 140. The user may input a query and a response may be provided (e.g., from the chat bot or customer service associate) via another dynamically generated user interface displayed by the user computing device 140. This process may continue until the user has determined or identified the desired payment device to complete the transaction.

In examples in which the transaction was initiated at a point-of-sale device 150, the user computing device 140 may generate and send a notification or user interface identifying the recommended payment device to the point-of-sale device 150 for display by the point-of-sale device at step 218. For instance, FIG. 6 includes an interface 600 that includes identification of the current payment device being used, as well as the identified recommended payment device. The interface 600 may include an option to proceed with the transaction using the current payment device or proceed using an alternate payment device.

At step 219, point-of-sale device 150 may receive and display the notification including the recommended payment device.

In some examples, if the transaction was initiated at a point-of-sale device 150, notifications including the recommended payment device may be generated and displayed on both the user computing device 140 and the point-of-sale device 150. Alternatively, the notification may be displayed on only one of the user computing device 140 or point-of-sale device 150.

At step 220, one or more of the user computing device 140 and/or the point-of-sale device 150 may receive user input, via the user interface providing the recommended payment device, of a payment device to continue the transaction. Regardless of whether the user selects to continue with the current payment device or use the recommended payment device, the user may provide user input identifying the payment device via one or more of user interface 500 or 600 (e.g., depending on the initiating device).

With reference to FIG. 2E, based on the user input provided, at step 221, the transaction may be processed using the selected payment device by either the user computing device 140 or the point-of-sale device 150.

At step 222, user computing device 140 may update and/or validate the micro language model based on, for instance, user selection of the original payment device or the recommended payment device, various transaction details, or the like. For instance, a dynamic feedback loop may be used to refine, update and/or validate the micro language model in order to continuously improve accuracy of the micro language model.

At step 223, device evaluation computing platform 110 may update and/or validate the large language model based on, for instance, the recommended payment device, acceptance or rejection of the recommended payment device, or the like. For instance, a dynamic feedback loop may be used to refine, update and/or validate the large language model in order to continuously improve accuracy of the large language model.

In some examples, user computing device 140 and/or device evaluation computing platform 110 may continuously update, validate, refine, or the like, the micro language model and/or large language model, respectively. In some arrangements, one or more of the user computing device 140 and/or device evaluation computing platform 110 may maintain an accuracy threshold for the micro language model and/or large language model, respectively, and may pause refinement (through a dynamic feedback loop) of the respective model if the corresponding accuracy is identified as greater than the accuracy threshold. Further, if the accuracy is at or below the accuracy threshold, the user computing device 140 and/or device evaluation computing platform 110 may resume refinement of the respective model through the corresponding dynamic feedback loop.

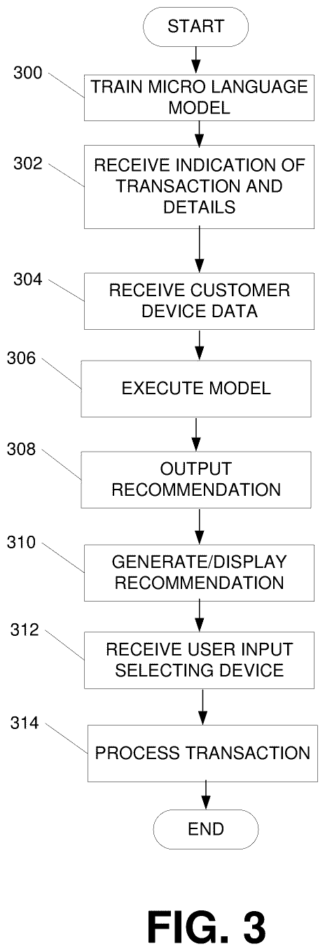

FIG. 3 is a flow chart illustrating one example method of leveraging hybrid language models for device evaluation in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a user computing device 140 may train a micro language model. For instance, the user computing device 140 may train a micro language model using historical user data from the device, from one or more other devices (e.g., enterprise computing system 120) and the like. Training the micro language model may cause the micro language model to identify correlations, sequences or patterns in data to identify, in real-time and during a transaction, a recommended payment device for the particular transaction (e.g., based on transaction details, customer specific information received from the large language model, and the like). In some examples, the user computing device 140 may be a mobile device of the user.

At step 302, the user computing device 140 may receive or detect an indication of initiation of a transaction. In some examples, the indication may include transaction details such as customer or user name, merchant name, amount of transaction, type of transaction, type of purchase, retailer name, a first payment device being used for the initiated transaction, and the like.

At step 304, the user computing device 140 may receive, from the device evaluation computing platform 110, and via a unified language model feed layer, customer specific payment device information. For instance, a large language model executing on the device evaluation computing platform 110 may process data related to various users or customers, payment devices associated with the users or customers, financial institutions associated with each payment device, rewards or benefits associated with each payment device, and the like, to generate or output customer specific payment device information including some or all payment devices associated with a customer, rewards or benefits associated with each payment device, financial institution associated with each payment device, and the like. The customer specific payment device information may be provided to the user computing device 140 for further processing by the micro language model and via a unified language model feed layer that may format data for use by the micro language model. In some examples, this information may be requested from the computing platform 110, may be transmitted by the computing platform 110 to the user computing device 140 on a periodic or aperiodic basis, or may be transmitted to the user computing device 140 in response to an indication of initiation of the transaction received by the device evaluation computing platform 110.

At step 306, the user computing device 140 may execute the micro language model using the transaction details and customer specific information as inputs to output a recommended payment device at step 308. In some examples, the recommended payment device may be a same device as the first payment device currently being used for the ongoing transaction, or may be a different payment device than the first payment device. The first payment device and recommended payment device may each be a debit card, credit card, or the like.

At step 310, the user computing device 140 may generate a notification including the recommended payment device and may display the notification on a display of the user computing device 140. In some arrangements, the notification may further include a selectable option to obtain additional information about the recommended payment device. In some examples, the notification may, additionally or alternatively, be transmitted to a point-of-sale device 150 (e.g., a point-of-sale device at which the transaction was initiated) and displayed by a display of the point-of-sale device 150.

At step 312, user computing device 140 may receive user input accepting or rejecting the recommended payment device, selecting one of the first payment device or recommended payment device, or the like. The user input may be received via the notification displayed on the user computing device 140.

In some examples, in which the recommendation is displayed by the point-of-sale device 150, the user input may be received by the point-of-sale device 150 and transmitted (e.g., via near field communication, Bluetooth™ or the like) to the user computing device 140.

At step 314, the user computing device 140 may process the transaction using the selected payment device.

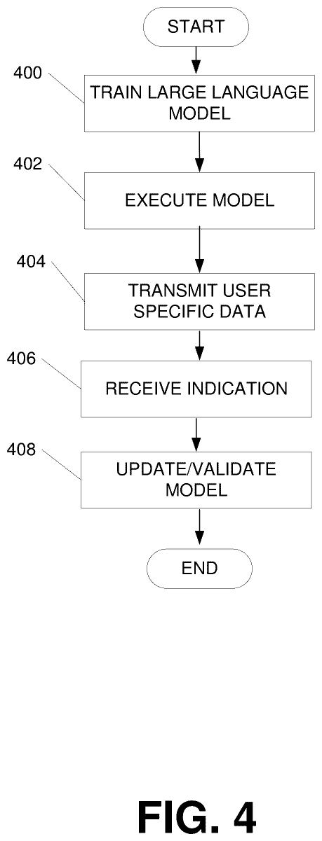

FIG. 4 is a flow chart illustrating another example method of leveraging hybrid language models for device evaluation in accordance with one or more aspects described herein. The processes illustrated in FIG. 4 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 4 may be performed in real-time or near real-time.

At step 400, device evaluation computing platform 110 may train a large language model. In some examples, data related to users, payment devices associated with the users, financial institutions associated with the payment devices, rewards or benefits associated with the payment devices, and the like, may be used to train the large language model. In training the large language model, the model may, in some examples, receive payment device data, historical transaction data, financial institution data, and the like, and may identify correlations, sequences or patterns in data to output customer or user specific payment device information or data related to one or more payment devices associated with a particular customer.

At step 402, device evaluation computing platform 110 may execute the large language model using, as inputs, user or customer identifying information, to output, for an identified user, user specific payment device information or data for one or more payment devices associated with the user. In some examples, the user specific payment device data may include a subset of one or more (or all) payment devices associate with the user and the subset may be customized based on historical user data, transaction details associated with a particular ongoing transaction of a user, or the like. In some examples, the large language model may be executed in response to receiving an indication of an ongoing transaction of a user (e.g., in real-time or near real-time).

At step 404, the device evaluation computing platform 110 may transmit or send the user specific payment device information to a user computing device 140 of the user. In some examples, the user specific payment device data may be sent via a unified language model feed layer that may format the data for further analysis or processing by a micro language model executing on the user computing device 140.

At step 406, device evaluation computing platform 110 may receive, from the user computing device 140, an indication of a recommended payment device (e.g., identified by the micro language model executing on the user computing device 140) and an indication of whether a recommendation to use the recommended payment device for an ongoing transaction was accepted.

At step 408, device evaluation computing platform 110 may update and/or validate the large language model based on the received indication of the recommended payment device and whether the recommendation was accepted.

Accordingly, aspects described herein leverage hybrid language models to evaluate payment devices, identify, in real-time, an optimal or recommended payment device for an ongoing transaction and update one or more models based on user input accepting or rejecting the recommendation.

As discussed herein, because users often have so many different payment devices (e.g., credit cards, debit cards, and the like) it can be difficult or impossible to identify a best payment device to use for any particular transaction. In addition, this issue is compounded when factoring in temporary incentives providing additional rewards or benefits for a particular card. Accordingly, the arrangements described herein leverage various language models to identify, in real-time and during an ongoing transaction, a recommended payment device for that particular transaction.

As discussed herein, in some examples, a notification may be generated and displayed to a user (e.g., via user computing device 140, point-of-sale device 150, or the like) identifying the recommended alternate payment device. In some arrangements, the notification may include identification of the recommended payment device. Additionally or alternatively, the notification may include additional information related to what benefit could be gained by using the recommended payment device, and/or may include a selectable option to obtain additional information.

The arrangements described herein rely on hybrid language models to understand the context of each payment device, including payment devices issued by financial institutions other than the financial institution executing the models, to asses, in real-time, current transaction details and provide a recommendation.

As discussed herein, by leveraging different types of language models, the arrangements described herein are able to quickly and efficiently process, in real-time, data associated with a transaction to provide a recommendation as the transaction is ongoing. Using a large language model on a back end to process the vast amounts of data associated with all payment devices of a user, and associated data, enables the systems to obtain the necessary information related to customer or user specific payment devices, while having sufficient computing resources to process the data. Further, using a micro language model having a narrowly tailored dataset enables efficient processing of the transaction data in real-time and on virtually any computing device, such as a mobile device of a user. The output from the large language model enables more efficient processing by the micro language model by feeding customer or user specific, customized data into the micro language model for efficient, real-time processing.

In some examples, the LLM may be executed to process the full set of data before a transaction is initiated. Accordingly, the systems may identify payment devices, financial institutions, and the like, to identify customized offers for a user based on various factors particular to the user. This data may then be passed to the micro language model executing on the user computing device to perform the real-time, transaction details-based analysis of the ongoing transaction and provide the recommended payment device to the user. Accordingly, the large language model provides the payment device context while the micro language model provides in-session transaction context.

Although the arrangements described include one large language model, more than one large language model may be used without departing from the invention. Further, in some examples, different types of technology may be used with the different large language models without departing from the invention.

As discussed herein, the unified language model feed layer may format data from the one or more large language models, from the different technologies used in the one or more large language models, to translate data for processing by the micro language model. This may enable efficient integration of data.

While various aspects discussed herein are directed to identifying a recommended payment device that is already associated with the user (e.g., the user already has the payment device), in some examples, a recommendation to obtain another payment device that may provide additional rewards or benefits. For instance, the requested or initiated transaction may be processed (e.g., without pause) and a recommendation for a user to apply for an additional payment device that would have provided an improved benefit or reward over the current payment device used may be provided to the user. In some examples, the notification including the recommendation may also include a link to a website to apply for the identified payment device.

Further, in some examples, if a user accepts a recommended payment device, a conditional reexamination may be performed to confirm that that is the best payment device for use in the transaction. In some examples, that may be performed by the micro language model on the user computing device and/or by the large language model on the computing platform.

In some examples, outputs from the models described herein may be fed back into one or more enterprise systems to generate, reconfigure, or the like, one or more rewards or benefits for various payment devices.

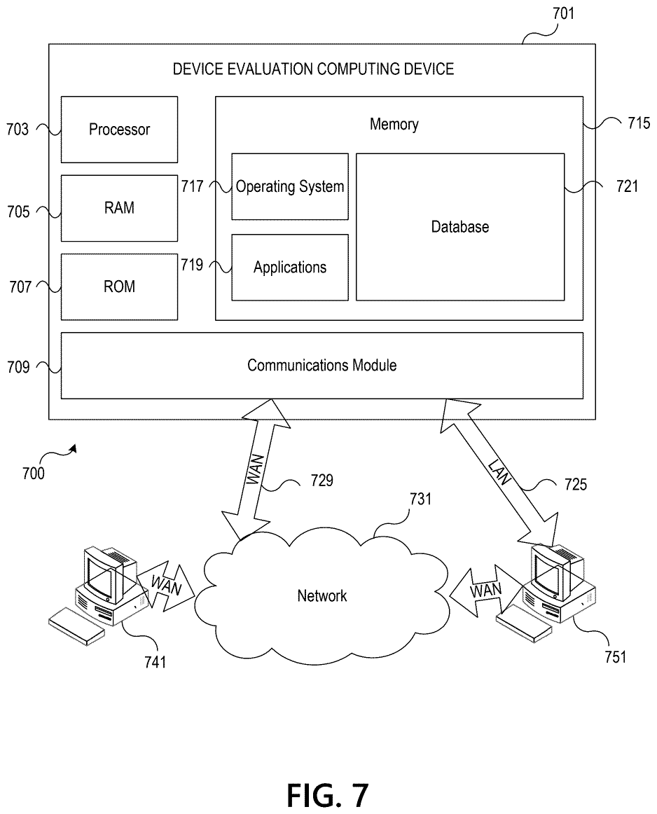

FIG. 7 depicts an illustrative operating environment in which various aspects of the present disclosure may be implemented in accordance with one or more example embodiments. Referring to FIG. 7, computing system environment 700 may be used according to one or more illustrative embodiments. Computing system environment 700 is only one example of a suitable computing environment and is not intended to suggest any limitation as to the scope of use or functionality contained in the disclosure. Computing system environment 700 should not be interpreted as having any dependency or requirement relating to any one or combination of components shown in illustrative computing system environment 700.

Computing system environment 700 may include device evaluation computing device 701 having processor 703 for controlling overall operation of device evaluation computing device 701 and its associated components, including Random Access Memory (RAM) 705, Read-Only Memory (ROM) 707, communications module 709, and memory 715. Device evaluation computing device 701 may include a variety of computer readable media. Computer readable media may be any available media that may be accessed by device evaluation computing device 701, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by device evaluation computing device 701.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on device evaluation computing device 701. Such a processor may execute computer-executable instructions stored on a computer-readable medium.

Software may be stored within memory 715 and/or storage to provide instructions to processor 703 for enabling device evaluation computing device 701 to perform various functions as discussed herein. For example, memory 715 may store software used by device evaluation computing device 701, such as operating system 717, application programs 719, and associated database 721. Also, some or all of the computer executable instructions for device evaluation computing device 701 may be embodied in hardware or firmware. Although not shown, RAM 705 may include one or more applications representing the application data stored in RAM 705 while device evaluation computing device 701 is on and corresponding software applications (e.g., software tasks) are running on device evaluation computing device 701.

Communications module 709 may include a microphone, keypad, touch screen, and/or stylus through which a user of device evaluation computing device 701 may provide input, and may also include one or more of a speaker for providing audio output and a video display device for providing textual, audiovisual and/or graphical output. Computing system environment 700 may also include optical scanners (not shown).

Device evaluation computing device 701 may operate in a networked environment supporting connections to one or more remote computing devices, such as computing devices 741 and 751. Computing devices 741 and 751 may be personal computing devices or servers that include any or all of the elements described above relative to device evaluation computing device 701.

The network connections depicted in FIG. 7 may include Local Area Network (LAN) 725 and Wide Area Network (WAN) 729, as well as other networks. When used in a LAN networking environment, device evaluation computing device 701 may be connected to LAN 725 through a network interface or adapter in communications module 709. When used in a WAN networking environment, device evaluation computing device 701 may include a modem in communications module 709 or other means for establishing communications over WAN 729, such as network 731 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
train, based on data related to a plurality of payment devices associated with a plurality of users, financial institutions associated with each payment device of the plurality of payment devices, and benefits associated with each payment device of the plurality of payment devices, a large language model, wherein training the large language model causes the large language model to output user specific payment device data for a plurality of devices;
execute the large language model, wherein executing the large language model includes inputting, to the large language model, user identifying information to output, for a user, user specific payment device information for one or more payment devices associated with the user;
transmit, to a user computing device associated with the user and via a unified language model feed layer, the user specific payment device information for the one or more payment devices associated with the user;
receive, from the user computing device associated with the user, an indication of a recommended payment device of the one or more payment devices associated with the user and an indication of whether a recommendation to use the recommended payment device for a transaction was accepted; and
update the large language model based on the indication of whether the recommendation to use the recommended payment device for the transaction was accepted.

2. The computing platform of claim 1, wherein the user specific payment device information includes identification of a customized subset of the one or more payment devices associated with the user.

3. The computing platform of claim 1, wherein executing the large language model is performed in response to the computing platform receiving an indication of initiation of a transaction by the user.

4. The computing platform of claim 3, wherein executing the large language model is performed in real-time during the transaction.

5. The computing platform of claim 3, wherein the indication includes identification of the user and transaction details of the transaction initiated by the user.

6. The computing platform of claim 5, wherein the user specific payment device information includes identification of a customized subset of the one or more payment devices associated with the user based on the identification of the user and the transaction details of the transaction initiated by the user.

7. The computing platform of claim 1, wherein the recommended payment device is identified based on execution of a micro language model by the user computing device.

8. The computing platform of claim 1, wherein the unified language model feed layer format the user specific payment device information output by the large language model for further processing by a micro language model executing on the user computing device.

9. A method, comprising:
training, by a computing platform, the computing platform having at least one processor, and memory, based on data related to a plurality of payment devices associated with a plurality of users, financial institutions associated with each payment device of the plurality of payment devices, and benefits associated with each payment device of the plurality of payment devices, a large language model, wherein training the large language model causes the large language model to output user specific payment device data for a plurality of devices;
executing, by the at least one processor, the large language model, wherein executing the large language model includes inputting, to the large language model, user identifying information to output, for a user, user specific payment device information for one or more payment devices associated with the user;
transmitting, by the at least one processor and to a user computing device associated with the user and via a unified language model feed layer, the user specific payment device information for the one or more payment devices associated with the user;
receiving, by the at least one processor and from the user computing device associated with the user, an indication of a recommended payment device of the one or more payment devices associated with the user and an indication of whether a recommendation to use the recommended payment device for a transaction was accepted; and
updating, by the at least one processor, the large language model based on the indication of whether the recommendation to use the recommended payment device for the transaction was accepted.

10. The method of claim 9, wherein the user specific payment device information includes identification of a customized subset of the one or more payment devices associated with the user.

11. The method of claim 9, wherein executing the large language model is performed in response to the computing platform receiving an indication of initiation of a transaction by the user.

12. The method of claim 11, wherein executing the large language model is performed in real-time during the transaction.

13. The method of claim 11, wherein the indication includes identification of the user and transaction details of the transaction initiated by the user.

14. The method of claim 13, wherein the user specific payment device information includes identification of a customized subset of the one or more payment devices associated with the user based on the identification of the user and the transaction details of the transaction initiated by the user.

15. The method of claim 9, wherein the recommended payment device is identified based on execution of a micro language model by the user computing device.

16. The method of claim 9, wherein the unified language model feed layer format the user specific payment device information output by the large language model for further processing by a micro language model executing on the user computing device.

17. One or more non-transitory computer-readable media storing instructions that, when executed by a computing platform comprising at least one processor, memory, and a communication interface, cause the computing platform to:
train, based on data related to a plurality of payment devices associated with a plurality of users, financial institutions associated with each payment device of the plurality of payment devices, and benefits associated with each payment device of the plurality of payment devices, a large language model, wherein training the large language model causes the large language model to output user specific payment device data for a plurality of devices;
execute the large language model, wherein executing the large language model includes inputting, to the large language model, user identifying information to output, for a user, user specific payment device information for one or more payment devices associated with the user;
transmit, to a user computing device associated with the user and via a unified language model feed layer, the user specific payment device information for the one or more payment devices associated with the user;
receive, from the user computing device associated with the user, an indication of a recommended payment device of the one or more payment devices associated with the user and an indication of whether a recommendation to use the recommended payment device for a transaction was accepted; and
update the large language model based on the indication of whether the recommendation to use the recommended payment device for the transaction was accepted.

18. The one or more non-transitory computer-readable media of claim 17, wherein executing the large language model is performed in response to the computing platform receiving an indication of initiation of a transaction by the user.

19. The one or more non-transitory computer-readable media of claim 18, wherein the indication includes identification of the user and transaction details of the transaction initiated by the user.

20. The one or more non-transitory computer-readable media of claim 19, wherein the user specific payment device information includes identification of a customized subset of the one or more payment devices associated with the user based on the identification of the user and the transaction details of the transaction initiated by the user.
